(19) United States
(12) Patent Application Publication
(10) Pub. No.: US 2002/0189423 A1
(43) Pub. Date: Dec. 19, 2002

(54) Protective cover for stringed musical instrument

(76) Inventor: Randall W. Brantley, St. Augustine, FL (US)

Correspondence Address: Thomas C. Saitta, Rogers Towers Bailey Jones & Gay, P.A., Suite 1500, 1301 Riverplace Blvd., Jacksonville, FL, 32207, US

(21) Appl. No.: 10/163,318

(22) Filed: Jun. 5, 2002

Related U.S. Application Data
(60) Provisional application No. 60/297,847, filed on Jun. 14, 2001.

(51) Int. Cl. G10G 1/00

(52) U.S. Cl. 84/453

(57) ABSTRACT

A backless cover for protecting the front of a necked stringed instrument when the instrument is supported in a generally vertical position, the cover having a front panel composed of a body portion and neck portion corresponding in configuration to the body and neck portion of the instrument, and having a pocket with an open bottom positioned at the end of the neck portion, such that the pocket can be placed onto the neck of the instrument to retain the cover with the front panel disposed over the front of the instrument.

This application claims the benefit of U.S. Provisional Application Serial No. 60/297,847, filed Jun. 14, 2001.

### BACKGROUND OF THE INVENTION

This invention relates generally to the field of protective covers for stringed musical instruments having extended necks, and more particularly to temporary protective covers composed of a generally flexible material, and even more particularly to protective covers which can be easily removed from the instrument when the instrument is displayed or propped on a stand in a generally vertical position, such that the covers mainly serve to protect the face or front of the instrument to prevent damage to the face and to prevent the accumulation of dust or debris.

Protective covers for necked, stringed musical instruments, such as guitars, violins, banjos, etc., are well known and comprise two main types. The first type of protective cover completely encloses the instrument, such that it must be removed to view or play the instrument. Such full covers are typically composed of relatively rigid and strong materials, such as metal or hard plastic, for use as storage, shipping or travel cases. Full covers may also be composed of softer, flexible materials, such as fabric or soft plastic, where the primary purpose of the cover is to maintain the instrument free from dirt, dust and the like. Entry means and closures must be provided to allow for removal and replacement of the cover, and these may comprise mechanical fasteners, zippers, snaps, elastic, straps, etc. A second type of protective cover is a partial cover, where only a portion of the instrument, for example the rear and sides of the sound box or body, is encased by the cover. These partial covers are typically designed to allow the instrument to be played without removing the cover, such that the strings are exposed even with the cover in place.

Representative examples of known covers for stringed instruments are disclosed in U.S. Pat. No. 5,725,094 to Moral, U.S. Pat. No. 4,177,847 to Spindler, U.S. Pat. No. D315,167 to Willis, U.S. Pat. No. D322,717 to Wyant, and U.S. Pat. No. D278,442 to Whomsley. The Moral, Spindler, Wyant and Whomsley devices are fabric covers that utilize drawstrings, elastic or similar fastener elements to secure the cover over the rear and sides of the instrument body, with the strings, pick-ups, etc. remaining exposed for play. Willis shows a cover for the back and sides of the instrument made from a rigid protective material, with the front of the instrument open for play.

When the instrument is being stored, or when the instrument is being played, the known covers are adequate for their desired purposes. The known covers are inadequate however for use in a common circumstance, that being when the stringed instrument is propped up by a stand in a generally vertical position and it is desired to be able to quickly remove or install the cover. This is very common in retail settings, where the instruments are displayed for viewing by the customers. It is also common in entertainment settings, where the musician wants to temporarily set down the instrument between songs or sets, as well as in home settings, where the musician wishes to store the instrument on a stand when it is not being played. A full cover completely hides the instrument from view, requires the instrument to be removed from the stand in order to install or remove the cover, and requires extended effort to insert and remove the instrument because the zipper, snaps, or other fastener elements must be addressed, such that the musician is less likely to replace the cover for short periods of inactivity, thereby leaving the instrument exposed to damage. The partial covers which allow playing do not protect the functional components of the instrument, especially the neck and string areas, the pick-ups, etc., which allows dust, sun, rain, etc. to more easily damage the functional components of the instrument.

It is therefore an object of this invention to provide a cover for a stringed musical instrument which is easily placed onto and removed from the instrument, especially when the instrument is mounted on a generally vertical support for display or storage, such that the cover can be placed onto or removed from the instrument without requiring the instrument to be removed from the stand or otherwise picked up. It is further desired to provide such a cover which protects the full front of the instrument from the deleterious effects of dust, sun, rain, etc.

### SUMMARY OF THE INVENTION

The invention is in general a backless cover for a necked, stringed musical instrument, such as a guitar, violin, banjo, etc., which protects the front of the instrument from the deleterious effects of dust, sun, rain, etc., and which can be easily placed onto and removed from the instrument even when the instrument is placed onto a support stand in a generally vertical position.

The backless cover comprises a front panel member which is preferably configured on its perimeter in the general frontal configuration of the instrument to be covered, the front panel member having a relatively slender neck portion corresponding to the neck of the instrument and a relatively broader body portion corresponding to the sound box or body portion of the instrument. The front panel member is preferably composed of a flexible sheet material, such as a fabric or soft plastic, padded or non-padded, and may be transparent, translucent or opaque. A pocket member is attached to the top end or head of the neck portion of the front panel, with the pocket extending from the rear of the front panel and having a opening on its bottom facing the direction of the body portion. The pocket member extends only a short distance down the neck portion toward the body portion and is sized so as to accommodate and receive the slightly wider head portion of the neck of the musical instrument.

The front panel may be provided with easily removed, temporary securing means for encircling the instrument, such as an elastic strap or a strap having hook and pile type fasteners. The cover may be provided with a side panel or panels attached to the perimeter of the front panel which extend rearward of the front panel to better secure the cover on the instrument by retarding lateral movement and to provide some additional protection. The neck pocket may also be provided with closure or securing means, such as elastic. Pockets for storage or other purposes may be provided on the front of the front panel member.

### BRIEF DESCRIPTION OF THE DRAWINGS

FIG. 1 is a perspective view of the cover of the invention placed on a stringed instrument.

FIG. 2 is a side view of the cover.

FIG. 3 is a rear view of the cover, showing a strap for securing the cover onto the instrument.

FIG. 4 is a side view of an alternative embodiment for the cover, where a side panel extends rearward from the front panel.

### DETAILED DESCRIPTION OF THE INVENTION

With reference to the drawings, the invention will now be described in detail with for the best mode and the preferred embodiment. In general, the invention is a backless cover 10 for a stringed instrument 99 having an extended neck portion, such as a guitar, violin, banjo, etc., which can be easily placed onto and removed from a stringed instrument when the instrument is mounted or supported by a stand in a generally vertical position, whereby the cover 10 does not completely encase the instrument 99.

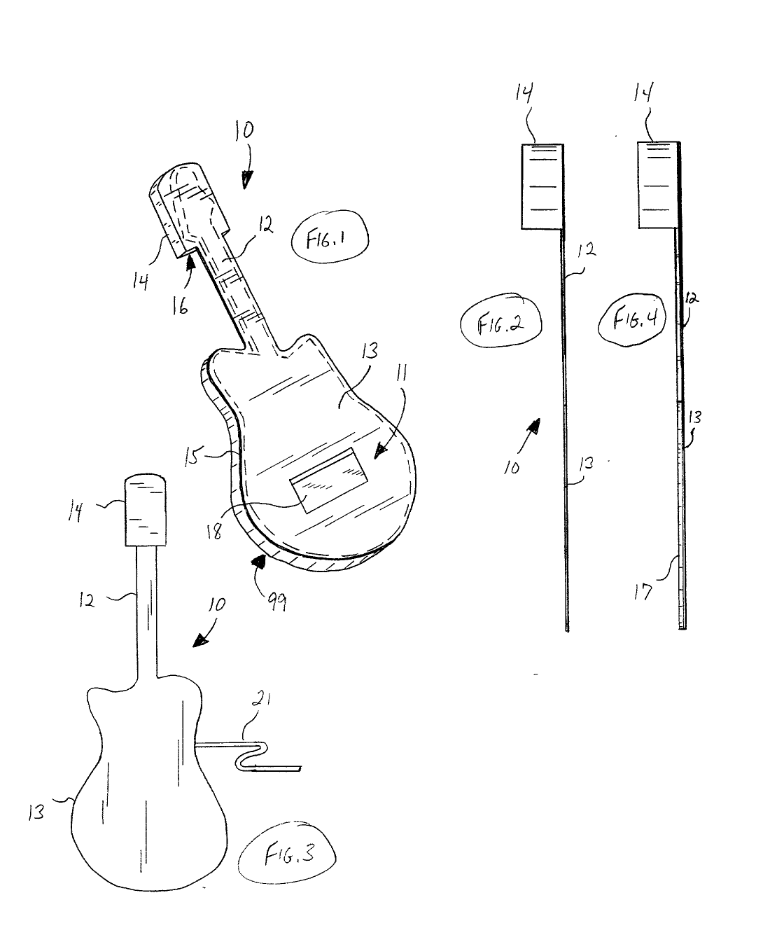

As seen in FIG. 1, the backless cover 10 comprises a front panel member 11 formed by the combination of a neck portion 12 and a body portion 13. The neck portion 12 is preferably sized and configured such that its peripheral edge or perimeter 15 matches or preferably exceeds the dimensions and configuration of the neck of the instrument 99 in length and width. The body portion 13 is likewise preferably sized and configured for the peripheral edge or perimeter 15 to match or preferably exceed the dimensions and configuration of the neck of the instrument 99 to be covered in length and width. Thus for example a body portion 12 designed for use with an acoustic guitar will have a generalized figure-eight shape, while the body portion 12 for a banjo will have a circular shape, while the body portion 12 for an electric guitar will have a non-symmetrical shape such as shown in the drawings. Alternatively, the cover 10 could be provided with a more universal or standardized shape such as a rectangle or ellipse for more universal applicability to instruments 99 of different size and configuration. The backless cover 10 is essentially flat or two dimensional, such that the thickness dimension is significantly smaller than the height and width dimensions.

A neck pocket 14 is positioned on the top or free end of the neck portion 12, opposite to the body portion 13, the neck pocket 14 having an opening 16 which faces downward in the direction of the body portion 13. The neck pocket 14 may be of many different shapes and is sized to receive the upper end or head of the musical instrument 99, such that the cover 10 can be easily draped onto the instrument 99 by dropping the opening 16 of the neck pocket 14 onto the exposed head, i.e., the top or upper end of the neck portion of the instrument 99, when the instrument is supported from the rear by a generally vertically oriented support stand of well known type. In this manner the front panel member 11 thereby rests on and covers the front side of the neck and body of the instrument 99. The pocket member 14 should be slightly oversized to allow for ease of placement and removal, or may be more correspondingly configured to match the particular configuration of the head of the instrument 99 for a more secure fit, or may be provided with elastic or other closure means such as zippers or snaps to provide a more secure attachment.

The backless cover 10 may be composed of many materials, but is preferably composed of a relatively thin, flexible, sheet material such as a fabric, soft polymer or combination of such materials. The cover 10 may be transparent, translucent or opaque, and may be padded or decorated. The cover 10 may also be provided with a closure or securing member 21 connected to the body portion 13, such as an elastic strap or one or more straps with a hook and loop type fastener, for example, which allows the cover 10 to be more securely affixed to the body of the instrument 99 if desired. Alternatively, the cover 10 may also be provided with a rearward extending side panel member or members 17 attached to all or part of the front panel member 11, as shown in FIG. 4. This side panel member 17 may extend only a short distance or may equal or exceed the depth of the body of the instrument 99, and serves to prevent lateral movement or slippage of the cover 10 relative to the instrument 99, as well as to provide increased obstruction to dust, water, etc. Storage pockets 18 for storage of picks, retention of display cards or other purposes, as well as other attachable accessories or features, may also be provided on the front panel member 10.

It is contemplated that certain equivalents and substitutions for components or elements set forth above may be obvious to those skilled in the art, and therefore the true scope and definition of the invention is to be as set forth in the following claims.

I claim:

1. A backless cover for a necked, stringed musical instrument, said cover comprising an elongated, relatively narrow neck portion, a relatively broad body portion connected to said neck portion, and a neck pocket attached to said neck portion, said neck pocket having an opening facing toward said body portion.

2. The cover of claim 1, wherein said neck portion and said back portion in combination define a flat front panel member.

3. The cover of claim 2, further comprising a storage pocket attached to said front panel member.

4. The cover of claim 1, wherein said neck pocket is attached to said neck portion opposite said body portion.

5. The cover of claim 1, wherein said cover is composed of a flexible sheet material.

6. The cover of claim 1, further comprising a side panel member extending from said body portion.

7. The cover of claim 1, further comprising a securing member attached to said body portion.

8. The cover of claim 6, wherein said securing member comprises a strap.

9. A backless cover for a necked, stringed musical instrument, said cover comprising:
an elongated, relatively narrow neck portion;
a relatively broad body portion joined to said neck portion, wherein the combination of said neck portion and said body portion define a front panel member which is generally flat; and
a neck pocket having an opening, said neck pocket joined to said neck portion such that said opening faces toward said body portion.

10. The cover of claim 9, wherein said neck pocket is joined to said neck portion opposite from said body portion.

11. The cover of claim 9, wherein said cover is composed of a flexible sheet material.

12. The cover of claim 9, further comprising a side panel member extending from said body portion.

13. The cover of claim 9, further comprising a securing member attached to said body portion.

14. The cover of claim 13, wherein said securing member comprises a strap.

15. A backless cover for the front of a stringed musical instrument having a body with a front, side and back, and a neck with a head, said cover comprising:
an elongated, relatively narrow neck portion adapted to cover the front of an instrument neck and head;
a relatively broad body portion joined to said neck portion and adapted to cover the front of an instrument body;
a neck pocket attached to said neck portion opposite from said body portion and adapted to receive an instrument head whereby said neck portion is disposed on an instrument neck and said body portion is disposed on an instrument body front with an instrument back remaining uncovered.

16. The cover of claim 15, wherein said cover is composed of a flexible sheet material.

17. The cover of claim 15, further comprising a side panel member extending from said body portion and adapted to cover an instrument side.

18. The cover of claim 15, further comprising a securing member attached to said body portion.

19. The cover of claim 18, wherein said securing member comprises a strap.

20. The cover of claim 15, wherein said body portion is configured to match the configuration of an instrument body.
